(19) United States
(12) Patent Application Publication
(10) Pub. No.: US 2020/0225073 A1
(43) Pub. Date: Jul. 16, 2020

(54) FILLING LEVEL MEASUREMENT SYSTEM AND METHOD

(71) Applicants: Wladimiro Villarroel, Lewis Center, OH (US); Eric Walton, Columbus, OH (US)

(72) Inventors: Wladimiro Villarroel, Lewis Center, OH (US); Eric Walton, Columbus, OH (US)

(21) Appl. No.: 16/248,511

(22) Filed: Jan. 15, 2019

(51) Int. Cl. G01F 23/28; G01F 23/284; G01F 23/292; G01F 23/296

(52) U.S. Cl. CPC G01F 23/28; G01F 23/2962; G01F 23/292; G01F 23/284

(57) ABSTRACT

Disclosed is a filling level measurement system and method for determining the level of a material within a container. The system and method are operative to provide a configuration that enables the transmission of an acoustic or an electromagnetic signal, which propagates along a channel having an end disposed at least in proximity to such material and produces a reflected signal. The system comprises a sensor capable of detecting such reflected signal, measuring the time from the transmission to the detection of the signal, and estimating the distance traveled by the signal to provide a measurement of the filling level of the container to a readout unit. The method provides the steps for properly calibrating and measuring the filling level of a container for different channel layouts. The system and method are particularly suitable for determining the appropriate timing for emptying the tank according to a specific application.

### FIELD OF THE INVENTION

The present invention relates to systems and methods for determining the filling level of a material within a container. More particularly, the present invention relates to systems and methods based on a range sensor for measuring the filling level of a material within a holding tank using acoustic or electromagnetic signals.

### BACKGROUND OF THE INVENTION

Systems and methods for determining the filling level of a material inside a container exist within various industries for effectively deciding when to empty or refill the container. The type and characteristics of the material and the container are important attributes that may define the type and location of the sensor to be used for determination of the level of fullness of the container. In particular, the flowability of the material in the container as well as the shape, dimensions, and building characteristics of the container, along with the number, location, and type of access points to the material inside the container are factors to be considered in designing a filling level measurement system.

Specifically, storage tank level monitoring systems and methods for determining fluid levels in a storage tank, using the transmission and reflection of ultrasonic and microwave signals, by deploying sensors and emitters to direct signals toward the material inside the container have been addressed in the prior art, as described in U.S. Pat. No. 4,487,065 to Carlin et al. and U.S. Pat. No. 5,877,663 to Palan et al. However, these methods are primarily aimed to determine the filling level of a tank by means of using sensors mounted on the interior of the tank to detect signals directly reflecting from the surface level of the material inside the tank.

On a bigger scale, the waste management industry uses containers to hold waste for a period of time before the contents of the container is extracted. Particularly in the construction, cargo, traveling, and vacationing industries various types of containers or holding tanks are designed to hold human waste. However, systems for measuring and reporting the level of the waste in the holding tank using components mounted on the interior of the tank tend to be expensive, inconvenient, and difficult to install and maintain because of the unsanitary and messy contents of the tank. As a result, in most cases in which no external system is used to indicate the level of fullness of the holding tank, the waste is extracted periodically facing the risks of getting an unusable tank after becoming full or an overflow of the tank. To avoid these risks, tank operators usually schedule the extraction of the contents of the tanks more often than required, which increases costs and reduces efficiency.

These challenges are critical for operators of marine vessels, because recent changes in US regulations prohibits the discharge of human waste into US waters. Most boats or ships with toilet facilities on board require the use of a holding tank so that discharge of waste into US waters does not happen. These tanks are emptied using a vacuum pump system attached to an output channel on the deck of the vessel. Thus it is particularly important for the boat operator to be able to estimate the level of waste in such holding tanks in order to meet with US regulations. However, in most cases this requires emptying the holding tank at a substantially earlier time than needed. This may lead to unnecessary docking of the vessel while navigating, the need to alter the desired navigation route and itinerary, a reduction of valuable operational time, an increase of the operational costs, and user's inconvenience. Accordingly, marine vessel operators would like to have a means to determine the filling level the material inside the container by installing or using a system that is mounted externally to the holding tank.

Previous efforts have been made to use sensors mounted externally to a container for determining the filling level of a material in the container, as described in U.S. Pat. No. 4,901,245 to Olson et al. However, these efforts have faced certain challenges and limitations. In particular, the sensor must be mounted to a bottom exterior location on the tank making the sensor installation in an operational holding tank costly and complicated. Another limitation may result by the need of such systems of a sensor that must be able to transmit a signal that penetrates the walls of the container and is able to propagate back and forth through the material inside the container to reach the surface level of the material inside the container. This requires more sophisticated, powerful, and/or sensitive sensors, and as a result more costly, in order to overcome the signal penetration through different materials and the corresponding signal propagation losses.

A way to address the disadvantages of the efforts attempted by the prior art is to implement a filling level measurement system that integrates a sensor in an external output channel of a container to determine the filling level of the container. This would make it possible to increase the robustness of the filling level measurement system, while mitigating or eliminating uncertainties about the level of material in the container. In particular, a configuration may be designed to integrate a sensor on either an existing cap or a replacement cap of the output channel of a container for additional advantages, including low cost, ease of installation and maintenance, reduction of operational costs, convenience, and more efficient use of time for an overall improved user's experience.

Currently, there is no well-established method of deterministically determining the filing level of a human waste holding tank of a vessel, as described in the present invention. More specifically, providing a sensor external to the tank, which does not require installation on or in the tank; a readout display on the cap of the output channel of the tank or on the screen of a mobile device, avoiding sensor wiring to a readout panel; and as cost-effective and easy to install and maintain system by just replacing a cap or adapting a relatively inexpensive sensor to an existing cap. As a result, users typically undergo an expensive sensor installation, experience an unexpected overflow of waste material, or conservatively empty the tank more often than necessary to reduce the likelihood of a leakage, based on the user's experience of the filling level of the tank. In particular, the filling level of a waste holding tank of a marine vessel is affected by various factors, including navigation time, number of passengers on board, last time tank was emptied, and diet and eating habits of passengers. Each of these factors is subject to uncertainties that create difficulties in accurately estimating the filling level of the tank.

Thus, there remains a need in the art for systems and methods capable of determining the filling level of a flowable material in a container, through measurements of propagating signals in an external channel, while avoiding the problems of prior art systems and methods.

### SUMMARY OF THE INVENTION

A system and method to measure the filling level of a material within a container is disclosed herein. One or more aspects of exemplary embodiments provide advantages while avoiding disadvantages of the prior art. The system and method are operative to provide a configuration that enables the transmission of an acoustic or an electromagnetic signal, which propagates along a channel having an end disposed at least in proximity to such material and produces a reflected signal. The system comprises a sensor capable of detecting such reflected signal, measuring the time from the transmission to the detection of the signal, and estimating the distance traveled by the signal to provide a measurement of the filling level of the container to a readout unit. The method provides the steps for properly calibrating and measuring the filling level of a container for different channel layouts. The system and method are particularly suitable for determining the appropriate timing for emptying the tank according to a specific application.

The system sensor further comprises a transducer to enable the transmission of a transduced signal into the channel, which is physically coupled and external to the container holding a flowable material. In the case of an output channel designed to extract the material from the container, the channel may consists of a hose or pipe that couples to an outlet of the container positioned around the bottom of the container. Moreover, the output channel typically runs smoothly to the extraction point of the material from the channel to prevent clogs of the material due to sharp corners or bends of the channel. As a result, part of the material occupies the channel at a level similar to that of the level of the material within the container.

The transduced transmission signal propagates inside the channel toward the container until reaching either the material occupying the channel or the outlet of the container, each of which represents a discontinuity to the propagating signal. At either of these two discontinuities, the transduced transmission signal is reflected back along the channel and detected by the sensor. A control and communications module in the sensor is able to measure the time from the launching of the transmission signal to the detection of the reflected signal, thus permitting to calculate the distance traveled by the signal, which corresponds to the distance between the sensor and the discontinuity. This distance is related to the filling level of the material within the container, so that after considering a calibration to compensate for the dimensions and pathway of the channel along with the size and geometry of the container, the level of the material in the container can be determined.

The system also includes a readout unit coupled to the control and communications module of the sensor. Since the sensor is preferably positioned inside and or in proximity to the end of the channel opposite the container, the sensor may wirelessly communicate with the readout unit, which may consist of a smartphone. Alternatively the sensor may be wired to the readout unit, which may consists of a display mounted on a cap covering the end of the channel opposite the container or on a panel.

Furthermore, the system is designed to reduce a plurality of reflections associated with the propagation of a signal transmitted by the sensor into the output channel of the container, by a sufficient extent so as to enable detection of the reflected signal from the remote discontinuity of either part of the material inside the output channel of the container or the outlet of the container. Accordingly, the transducer of the sensor used to transmit such signal is physically configured and comprises a matching section to efficiently couple the signal transmitted or received by the sensor transducer to or from the output channel of the container.

The system may be used in determining the filling level of human waste material in a holding tank of a marine vessel to efficiently decide when to extract the material from the tank. In this case, the sensor may consists of an acoustic, radar, or optical device mounted onto or near the cap of the hose or pipe running from the bottom of the holding tank to the deck of the vessel.

The method to determine the filling level of a container, containing a flowable material includes the step of setting up the inside the output channel of a container, such that the sensor is able to transmit a transmission signal toward the container. The method further includes the steps of generating a transduced transmission signal that propagates along the output channel of the container and detecting the amplitude and measuring the time of arrival of the reflected signal produced upon impingement of the transduced transmission signal on either a part of the material inside the container that may occupy a portion of the output channel of the container or the outlet of the container. The method also includes calibrating the distance traveled by the reflected signal, based upon a known propagation velocity of the transmission and reflected signals along the output channel of the container, to determine the filling level of the container.

By determining the distance from the sensor to a remote discontinuity in the output channel of a container, corresponding to the fullness of a container, and by reducing the level of reflections and ringing of both a transmission signal and a reflected signal, the system and method are able to determine the filling level of a container containing a flowable material.

### BRIEF DESCRIPTION OF THE DRAWINGS

The numerous advantages of the present invention may be better understood by those skilled in the art by reference to the accompanying drawings in which:

FIG. 1 shows a schematic view of an exemplary embodiment of a filling level measurement system.

FIG. 2 shows a functional schematic view of an exemplary embodiment of a sensor used in a filling level measurement system.

FIG. 3 shows a schematic view of a method for determining the filling level of a container according to any of the embodiments of the invention.

### DESCRIPTION OF THE INVENTION

The following description of particular embodiments of the invention is set out to enable one to practice an implementation of the invention and is not intended to limit the invention to any specific embodiment, but to serve as a particular example thereof. Those skilled in the art should appreciate that they may readily use the conception and specific embodiments disclosed herein as a basis for modifying or designing other methods and systems for carrying out the same purposes of the present invention. Those skilled in the art should also realize that such equivalent assemblies do not depart from the spirit and scope of the invention in its broadest form.

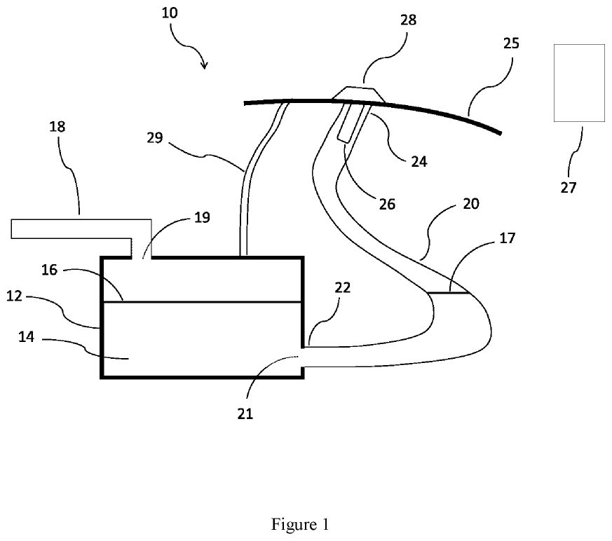

In accordance with certain aspects of an embodiment of the invention, a filling level measurement system 10 is shown in FIG. 1. System 10 comprises a container 12 containing a material 14, which defines a container filling level at a surface 16 of material 14. System 10 further comprises an input channel 18 to discharge material 14 into container 12 through an inlet 19 of container 12, and an output channel 20 to extract material 14 from container 12 through an outlet 21 of container 12. A first end 22 of channel 20 is mechanically coupled to outlet 21 of container 12, while a second end 24 of channel 20 is mechanically coupled to a supporting structure 25 in proximity to a sensor 26. A cap or lid 28 covers second end 24 of channel 20 to prevent material 14 or fumes produced in container 12 from exiting through second end 24 of channel 20 under normal operating conditions. System 10 further comprises a readout unit 27 for showing the filling level of container 12. Those skilled in the art should realize that a vent line 29 and/or a small hole in cap 28 may be implemented to prevent pressure build-up in container 12 and channel 20.

Preferably, sensor 26 is inserted within channel 20 and is attached to cap 28, covering second end 24 of channel 20. Thus when cap 28 is removed for pumping out material 14 from container 12, sensor 26 is also removed by being attached to cap 28. In addition, first end 22 of output channel 20 and outlet 21 of container 12 are coupled at a location positioned at or in proximity to the bottom area of container 12. Accordingly, a part of material 14 occupies a portion of output channel 20 and defines an output channel filling level at a surface 17 of the part of material 14 occupying output channel 20.

Sensor 26 may comprise an ultrasonic sonar, a radar, or an optical device further comprising a transmitter and a receiver. The signal transmitted by the transmitter of sensor 26 is mostly confined inside and propagates from second end 24 to first end 22 along output channel 20, following the geometry of output channel 20, including any curves or bends. A reflected signal reflects back to sensor 26, once the signal transmitted by sensor 26 impinges upon surface 17 of the part of material 14 occupying output channel 20, and is detected by the receiver of sensor 26. Sensor 26 further comprises a microcontroller that measures the delay from the time the signal is transmitted by sensor 26 to the time the corresponding reflected signal is detected by sensor 26. This delay time provides information as to the distance from sensor 26 to surface 17 of the part of material 14 occupying output channel 20 and allows determining the output channel filling level at surface 17 of the part of material 14 occupying output channel 20. Those skilled in the art will realize that by a preliminary calibration of the corresponding container filling level at surface 16 of material 14 to the output channel filling level at surface 17 of the part of material 14 occupying output channel 20, it is possible to determine the level of material 14 within container 12. Once the fullness of container 12 is determined, the corresponding information may be wirelessly transmitted to be shown on a remotely located readout unit 27, such as a phone or a display. Alternatively readout unit 27 may be implemented by means of a display placed on sensor 26 or cap 28.

In a preferred embodiment, system 10 is configured to measure filling level 16 of container 12, which consists of a marine holding tank containing human waste material 14. Furthermore, material 14 is discharged to container 12 from a sink, toilet or the like coupled to inlet 19 through input channel 18, which may consist of a main hose or pipe further coupled to a plurality of pipes. Thus, in this particular embodiment, material 14 is typically flowable and periodically extracted from container 12 using a vacuum pumping system through outlet 21 and output channel 20, which may consist of a pipe or hose that leads to a deck 25 of a marine vessel.

Moreover, vent line 29 may consist of an air vent using a small hose or pipe running from container 12 to a location on deck 25 or other outer surface of the marine vessel. Accordingly, the container filling level at surface 16 of flowable material 14 and the output channel filling level at surface 17 of the part of flowable material 14 occupying output channel 20 will at least be proportionally correlated. Furthermore a calibration of the system permits an accurate readout of the level of fullness of container 12. In one calibration approach, the distance from sensor 26 to the output channel filling level at surface 17 of the part of material 14 occupying output channel 20, after a complete pump-out of material 14, defines an “empty” level of container 12. The known geometry and dimensions of container 12 then permits to correlate the percentage of fullness of container 12, based on the distance from sensor 26 to the output channel filling level at surface 17 of the part of material 14 occupying output channel 20. In addition, the pathway and the slope of output channel 20 from container 12 to deck 25 of the marine vessel will affect the calibration and should be taken into account. Alternatively, more specific calibration algorithms can be used as known to those skilled in the art.

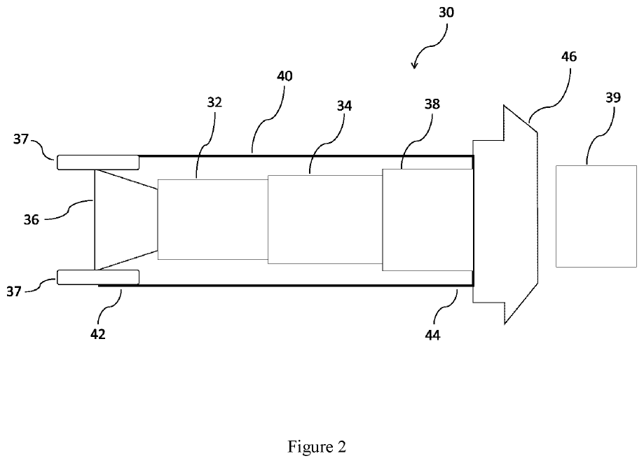

FIG. 2 shows a functional schematic view of an exemplary embodiment of a sensor 30 used in a filling level measurement system. More specifically, FIG. 2 shows a longitudinal cross-sectional view of a preferred embodiment of sensor 30, comprising a transceiver (transmitter and receiver) module 32, a control and communications unit 34, a transducer 36, and a power module 38. Preferably sensor 30 fits within a cylindrical housing 40 that is waterproof sealed to prevent water, moisture, and other potential contaminants from getting in contact with internal components of sensor 30. More preferably, cylindrical housing 40 is inserted within an output channel of a container. Moreover, a first end 42 of sensor 30 is positioned as the most inner section of sensor 30 within the output channel of the container, while a second end 44 of sensor 30 attaches to a cap 46 of such output channel of the container.

In particular, transceiver module 32 comprises a transmitter, which generates a transmission signal, and a receiver, which detects a reflected signal. Both the transmission signal and the reflected signal primarily propagate along the output channel of the container. Specifically, control and communications unit 34 enables the activation of transceiver module 32 for sending a transmission signal along the output channel of the container and for timing both the signal transmission as well as the detection of any reflections of the transmission signal while propagating along the output channel of the container. Preferably, the control functions of control and communications unit 34 are performed by a microcontroller, such as a Raspberry PI 3. Moreover, control and communications unit 34 further comprises a radio communications link between sensor 30 and a readout unit 39. Most preferably the radio communications link is a very low power Bluetooth system and readout unit 39 is a smartphone, which may include the calibration and display algorithms.

Those skilled in the art should realize other ways to interconnect control and communications unit 34 and readout unit 39 of various types. As an example, sensor 30 may alternatively be designed to provide a wired connection to a display embedded in or physically connected to cap 46, such that no wireless communication system would be required or a remotely located display. In these configurations, the filling level of the container could be directly displayed on such display. Additionally, power module 38 preferably consists of an internal battery, such as those used for toys and electronic devices. Sensor 30 is designed to operate on a low power budget and as such is capable to run several months on a single battery charge. The electronic components that are used for performing the functions of transceiver module 32, control and communications unit 34, and power module 38 are well known, and are shown only schematically.

More specifically, transducer 36 of sensor 30 consists of a device capable of converting an electric signal generated by transceiver module 32 into a transmission signal to be propagated along the output channel of the container. Likewise transducer 36 of sensor 30 is also capable of converting a reflected signal, which propagates along the output channel of the container and is received by sensor 30, into an electric signal received by transceiver module 32.

Importantly, at the interface between transducer 36 and the internal part of housing 40 and at the interface between transducer 36 and the internal surface of the output channel of the container a plurality of undesired multiple reflections and ringing of the transmitted and reflected signals may generate. These effects may reach up to a level where the receiver of transceiver module 32 may be saturated, unable to detect a reflected signal of interest, or erroneously detect an undesired signal, resulting in inaccurate readings of the filling level of the container. An approach to mitigate undesired signal ringing and undesired multiple signal reflections is to physically configure transducer 36 such that the transmission signal is primarily focused around the center region of the output channel of the container as compared to the areas closer to the internal surface of the output channel of the container.

In a preferred configuration, transducer 36 consists of a conically-shaped device with a wider cross-section closer to first end 42 of sensor 30, specifically selected for the type of signal to be transmitted by sensor 30. Accordingly, transducer 36 may consist of a horn antenna for a radar signal, a conical acoustic transducer for a sonar signal, or a laser or one or more light-emitting-diodes (LEDs) for an optical signal, as well-known to those skilled in the art. Moreover, the configuration and operational characteristics, including type, frequency of operation, bandwidth, and power, of transducer 36 and transceiver module 32 are selected according to the specific output channel of the container to make sure the transmission signal propagates along the output channel of the container, as well-known to those skilled in the art.

In another aspect of an embodiment of the present invention, sensor 30 further comprises a matching section 37, which permits efficient coupling of the signal transmitted or received by transducer 36 to or from the output channel of the container. In a preferred configuration, matching section 37 is physically configured to adapt to the internal part of housing 40 and/or the internal surface of the output channel of the container. In reference to FIG. 2, matching section 37 preferably consists of a cylindrical section of a material capable of preventing the reflection of the undesired signals generated around the areas where transducer 36 is closer to the internal surface of the output channel of the container. Preferably, matching section 37 is a waterproof material, such as foam, that surrounds transducer 36. More preferably, matching section 37 is specifically selected according to the type of signal to be transmitted by sensor 30. Accordingly, matching section 37 may consist of a radiofrequency absorbing material for a radar signal, an acoustic absorbing material for a sonar signal, or a light absorbing material for an optical signal, as well-known to those skilled in the art.

In a preferred embodiment, the transmission signal consist of a plurality of either acoustic or electromagnetic (including optical) pulses sent in a burst. Then the signal transmission is stopped for a waiting period long enough to allow such signal to travel back and forth from first end 42 of sensor 30 to the container. During such waiting period, control and communications unit 34 measures the delay time since the transmission of the signal until a reflected signal is detected by transceiver module 32. The measured delay time allows determining the distance between first end 42 of sensor 30 and the filling level of the output channel of the container, based upon a known propagation velocity of the signal along the output channel. This distance is indicative of the fullness of the container, according to a calibration that correlates the filling level of the output channel and the filling level of the container. Then the information corresponding to the filling level of the container may be displayed in readout unit 39.

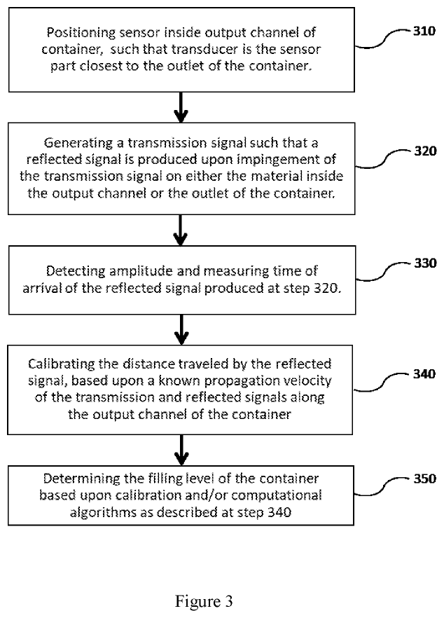

Regarding each of the above-described configurations, a method depicted in FIG. 3 for determining the filling level of a container, containing a flowable material, may be performed according to the following:

1. At step 310, setting up a sensor by positioning the sensor inside an output channel of a container, such that the location of a transducer of the sensor is the portion of the sensor closest to the outlet of the container.

2. Next, at step 320, generating a transduced transmission signal that propagates along the output channel of the container, such that a reflected signal is produced upon impingement of the transduced transmission signal on either a part of the material inside the container that may occupy a portion of the output channel of the container or the outlet of the container, and such reflected signal propagates along the output channel of the container.

3. Next, at step 330, detecting the amplitude and measuring the time of arrival of the reflected signal produced at step 320.

4. Next, at step 340, calibrating the distance traveled by the reflected signal, based upon a known propagation velocity of the transmission and reflected signals along the output channel of the container, by implementing at least one of the following approaches:
4.1 Defining a reference data set in which such distance may be associated to a filling level of the container under consideration, based on known filling levels of the container, e.g., empty and/or at different known levels of fullness.
4.2 Developing a calibration algorithm in which such distance may be associated to a filling level of the container under consideration, based on the geometry and dimensions of the container and the pathway and the slope of output channel.

5. Last, at step 350, determining the filling level of the container based upon calibration and/or computational algorithms as described at step 340.

Those of ordinary skill in the art will recognize that the steps above indicated can be correspondingly adjusted for specific configurations and other constraints such as transducer used, operating frequency band, type of sensor, operational conditions, surrounding environment, and available area and location for implementation of the filling level measurement system for a given application.

Additionally, the above-described filling level system may be designed and implemented from scratch. More importantly, the system may be implemented in existing set ups, while at least a part of the system is already in place. Specifically, the system may be implemented in a marine vessel having a waste holding tank by simply attaching a sensor to an existing cap of the output channel of the tank and using a remote readout unit able to communicate with the sensor. Preferably, the sensor is pre-attached to a cap that replaces the existing cap of the output channel of the holding tank, and the readout unit consists of a smartphone, a tablet, or a computer with a display, able to communicate via Bluetooth or WiFi with the sensor. More preferably, a software application installed in the readout unit allows to determine the filling level of the holding tank and displays such information.

The various embodiments have been described herein in an illustrative manner, and it is to be understood that the terminology used is intended to be in the nature of words of description rather than of limitation. Any embodiment herein disclosed may include one or more aspects of the other embodiments. The exemplary embodiments were described to explain some of the principles of the present invention so that others skilled in the art may practice the invention. Obviously, many modifications and variations of the invention are possible in light of the above teachings. The present invention may be practiced otherwise than as specifically described within the scope of the appended claims and their legal equivalents.

What is claimed is:

1. A system for determining a filling level of a material occupying a container, comprising:
a sensor further comprising a transmitter and a receiver;
a channel having a first end and a second end;
a transducer;
a readout unit;
wherein said first end of said channel is in close proximity to said material, and said second end of said channel is in close proximity to said sensor, wherein said transmitter generates a transmission signal that is transduced by said transducer and propagates through said channel, and said receiver detects a reflected signal that propagates through said channel after said reflected signal has been transduced by said transducer, wherein said reflected signal is produced by said transduced transmission signal being at least partly reflected from said material at a calibrated level of said material, wherein said sensor is able to measure a delay time between said transmission signal generated by said transmitter and said reflected signal detected by said receiver and compute a distance from said second end of said channel to said calibrated level of said material to determine said filling level, based upon said distance traveled by said reflected signal detected by said receiver, wherein said channel is external to said container, and wherein said readout unit displays information about said filling level.

2. The system of claim 1, wherein at least a portion of said first end of said channel is in physical contact with said material.

3. The system of claim 1, wherein at least a portion of said second end of said channel is in physical contact with a structural part to which said sensor is attached.

4. The system of claim 1, wherein said channel is at least partly within said container.

5. The system of claim 1, wherein said first end of said channel is in close proximity to a level of said material selected from the group of a bottom level of occupation of said material within said container and a top level of occupation of said material within said container.

6. The system of claim 1, wherein said calibrated level of said material corresponds to at least one point within said channel between said first end of said channel and said second end of said channel.

7. The system of claim 1, wherein said channel is used to extract said material from said container.

8. The system of claim 1, further comprising an inlet for depositing said material within said container, wherein said inlet is different from said channel.

9. The system of claim 1, wherein said channel consists of an element selected from the group of a pipe, a hose, and a tube.

10. The system of claim 1, wherein said sensor further comprises a means to couple said transduced transmission signal to said second end of said channel to reduce the detection by said receiver of undesired reflections and ringing of said transduced transmission signal.

11. The system of claim 1, wherein said container consists of a waste holding tank.

12. The system of claim 11, wherein said waste holding tank is part of a vessel.

13. The system of claim 1, wherein said sensor is disposed within said channel.

14. The system of claim 1, wherein said sensor is integrated with a cap that covers said second end of said channel.

15. The system of claim 1, wherein said transduced transmission signal consists of a type of signal selected from the group of acoustic, electromagnetic, and optical.

16. The system of claim 1, further comprising a radio communications sub-system to wirelessly communicate said information about said filling level of said material occupying said container to said readout unit.

17. The system of claim 1, wherein said calibrated level of said material is determined based upon a known velocity of said reflected signal propagating through said channel.

18. A method for determining a filling level of a material occupying a container, comprising:
a. providing a system for determining a filling level of a material occupying a container, comprising:
a sensor further comprising a transmitter and a receiver;
a channel having a first end and a second end;
a transducer;
a readout unit;
wherein said first end of said channel is in close proximity to said material, and said second end of said channel is in close proximity to said sensor, wherein said transmitter generates a transmission signal that is transduced by said transducer and propagates through said channel, and said receiver detects a reflected signal that propagates through said channel after said reflected signal has been transduced by said transducer, wherein said reflected signal is produced by said transduced transmission signal being at least partly reflected from said material at a calibrated level of said material, wherein said sensor is able to measure a delay time between said transmission signal generated by said transmitter and said reflected signal detected by said receiver and compute a distance from said second end of said channel to said calibrated level of said material to determine said filling level, based upon said distance traveled by said reflected signal detected by said receiver, wherein said channel is external to said container, and wherein said readout unit displays information about said filling level;
b. placing said sensor such that said transduced transmission signal primarily propagates from said second end of said channel to said first end of said channel;
c. detecting said reflected signal; and
d. determining said filling level based upon a distance traveled by said reflected signal detected by said receiver.

19. The method of claim 18, wherein determining said filling level further comprises:
a. measuring a time of travel of said reflected signal detected by said receiver, based upon a known propagation velocity of said reflected signal along said channel;
b. calibrating said distance traveled by said reflected signal detected by said receiver to determine said calibrated level of said material; and
c. determining said filling level based upon said calibrated level of said material.

20. The method of claim 19, wherein calibrating said distance traveled by said reflected signal detected by said receiver is associated to said filling level of said container by following an approach selected from the group of defining a reference data set, based upon known a priori filling levels of said container, and developing a calibration algorithm, based on a dimensional geometry of said container and a pathway and a slope of said channel.
